(19) United States
(12) Patent Application Publication
(10) Pub. No.: US 2009/0006777 A1
(43) Pub. Date: Jan. 1, 2009

(54) APPARATUS FOR REDUCING CACHE LATENCY WHILE PRESERVING CACHE BANDWIDTH IN A CACHE SUBSYSTEM OF A PROCESSOR

(76) Inventors: Greggory D. Donley, San Jose, CA (US); William A. Hughes, San Jose, CA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/769,970

(22) Filed: Jun. 28, 2007

(51) Int. Cl. G06F 12/00

(52) U.S. Cl. 711/154; 711/E12.001

(57) ABSTRACT

A processor cache memory subsystem includes a cache controller coupled to a tag logic unit. The cache controller may monitor read request resources associated with the cache subsystem and receive read requests for data stored in a data storage array of the cache subsystem. The tag logic unit may determine whether one or more requested address bits match any address tag stored within a tag array of the cache subsystem. The cache controller may, in response to determining the read request resources associated with the cache subsystem are available, selectably send the request for data with an implicit request indication being asserted. In response to determining the read request resources associated with the cache subsystem are not available, the cache controller may send the request for data without an implicit request indication being asserted.

### BACKGROUND OF THE INVENTION

1. Field of the Invention

This invention relates to microprocessor caches and, more particularly, to selectively reducing latency associated with retrieving cache data.

2. Description of the Related Art

Since a computer system's main memory is typically designed for density rather than speed, microprocessor designers have added caches to their designs to reduce the microprocessor's need to directly access main memory. A cache is a small memory that is more quickly accessible than the main memory. Caches are typically constructed of fast memory cells such as static random access memories (SRAMs) which have faster access times and bandwidth than the memories used for the main system memory (typically dynamic random access memories (DRAMs) or synchronous dynamic random access memories (SDRAMs)).

Modern microprocessors typically include on-chip cache memory. In many cases, microprocessors include an on-chip hierarchical cache structure that may include a level one (L1), a level two (L2) and in some cases a level three (L3) cache memory. Typical cache hierarchies may employ a small fast L1, cache that may be used to store the most frequently used cache lines. The L2 may be a larger and possibly slower cache for storing cache lines that are accessed but don't fit in the L1. The L3 cache may be still larger than the L2 cache and may be used to store cache lines that are accessed but do not fit in the L2 cache. Having a cache hierarchy as described above may improve processor performance by reducing the latencies associated with memory access by the processor core.

When a microprocessor needs data from memory, the processor typically first checks the L1 cache to see the if the required data has been cached. If not, the data is requested from the L2 cache. If the L2 cache is storing the data, it provides the data to the microprocessor (typically at much higher rate than the main system memory is capable of). If the data is not cached in the L1 or L2 caches (referred to as a “cache miss”), the data is requested from the L3 cache. Lastly, if the data is not in the L3 cache, the data is provided by main system memory or some type of mass storage device (e.g., a hard disk drive).

As described above, typically the farther the cache is away from the processor core, each level of cache increases in size, thereby providing more and more storage and opportunities to not be forced to access main memory. However, the increase in size may also cause a corresponding increase in the latencies associated with cache accesses. For example, as cache size increases, the time required to merely distribute tag accesses to all of the tag storage arrays and to return the results may begin to have an adverse impact on performance.

### SUMMARY

Various embodiments of an apparatus for reducing cache latency of a processor cache memory subsystem while preserving bandwidth are disclosed. In one embodiment, the processor cache memory subsystem includes a cache controller coupled to a tag logic unit. The cache controller may be configured to monitor read request resources associated with the cache memory subsystem and to receive read requests for data stored in a data storage array of the cache memory subsystem. The tag logic unit may be configured to determine whether one or more address bits associated with the read request match any address tag stored within a tag storage array of the cache memory subsystem. In addition, the cache controller may determine whether the read request resources associated with the cache memory subsystem are available. The cache controller may also selectably send the request for data without waiting for a hit indication dependent upon whether the read request resources associated with the cache memory subsystem are available.

In one specific implementation, in response to determining the read request resources associated with the cache subsystem are available, the cache controller is configured to request the data corresponding to the read request from the tag logic unit without waiting for a hit indication from the tag logic unit. For example, the cache controller may send to the tag logic unit, the request for data corresponding to the read request with an implicit request indication being asserted.

In another specific implementation, the cache controller may be configured to request only tag results from the tag logic unit in response to determining the read request resources associated with the cache subsystem are not available. For example, the cache controller may request only tag results by sending to the tag logic unit, the request for data corresponding to the read request without an implicit request indication being asserted.

### BRIEF DESCRIPTION OF THE DRAWINGS

FIG. 1 is a block diagram of one embodiment of a computer system including a multi-core processing node.

FIG. 2 is a block diagram illustrating more detailed aspects of an embodiment of the L3 cache subsystem of FIG. 1.

FIG. 3 is a flow diagram describing the operation of one embodiment of the L3 cache subsystem.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

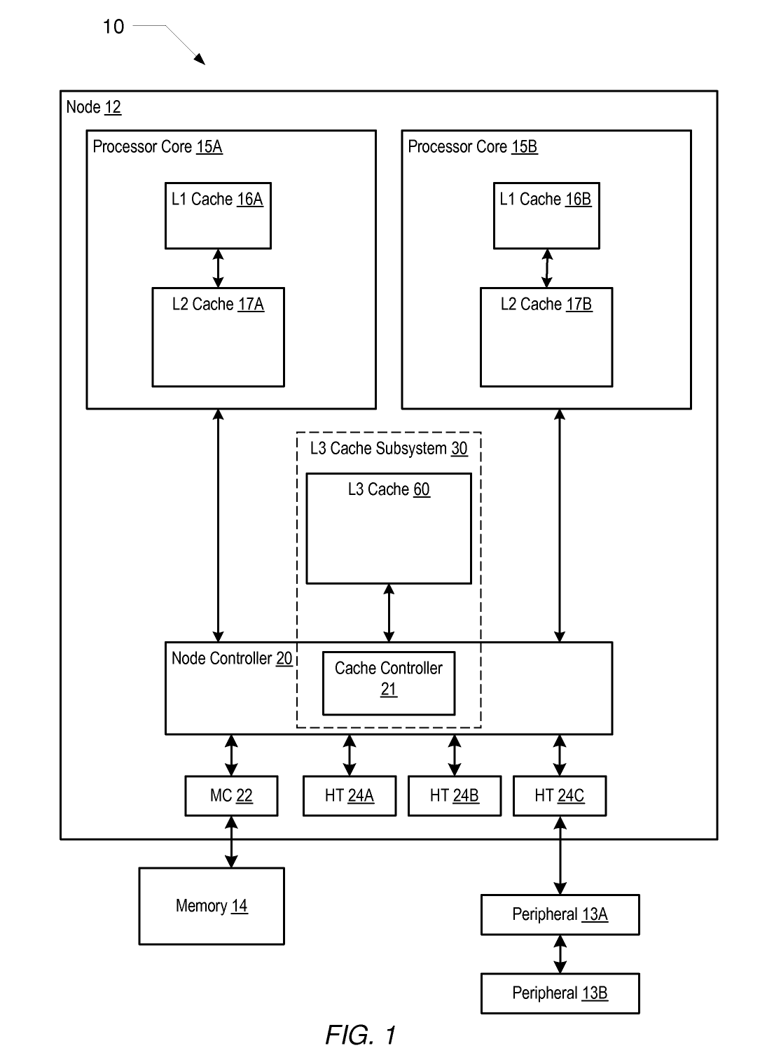

Turning now to FIG. 1, a block diagram of one embodiment of a computer system 10 is shown. In the illustrated embodiment, the computer system 10 includes a processing node 12 coupled to memory 14 and to peripheral devices 13A-13B. The node 12 includes processor cores 15A-15B coupled to a node controller 20 which is further coupled to a memory controller 22, a plurality of HyperTransport™ (HT) interface circuits 24A-24C, and a shared level three (L3) cache memory 60. The HT circuit 24C is coupled to the peripheral device 16A, which is coupled to the peripheral device 16B in a daisy-chain configuration (using HT interfaces, in this embodiment). The remaining HT circuits 24A-B may be connected to other similar processing nodes (not shown) via other HT interfaces (not shown). The memory controller 22 is coupled to the memory 14. In one embodiment, node 12 may be a single integrated circuit chip comprising the circuitry shown therein in FIG. 1. That is, node 12 may be a chip multiprocessor (CMP). Any level of integration or discrete components may be used. It is noted that processing node 12 may include various other circuits that have been omitted for simplicity.

In various embodiments, node controller 20 may also include a variety of interconnection circuits (not shown) for interconnecting processor cores 15A and 15B to each other, to other nodes, and to memory. Node controller 20 may also include functionality for selecting and controlling various node properties such as the maximum and minimum operating frequencies for the node, and the maximum and minimum power supply voltages for the node, for example. The node controller 20 may generally be configured to route communications between the processor cores 15A-15B, the memory controller 22, and the HT circuits 24A-24C dependent upon the communication type, the address in the communication, etc. In one embodiment, the node controller 20 may include a system request queue (SRQ) (not shown) into which received communications are written by the node controller 20. The node controller 20 may schedule communications from the SRQ for routing to the destination or destinations among the processor cores 15A-15B, the HT circuits 24A-24C, and the memory controller 22.

Generally, the processor cores 15A-15B may use the interface(s) to the node controller 20 to communicate with other components of the computer system 10 (e.g. peripheral devices 16A-16B, other processor cores (not shown), the memory controller 22, etc.). The interface may be designed in any desired fashion. Cache coherent communication may be defined for the interface, in some embodiments. In one embodiment, communication on the interfaces between the node controller 20 and the processor cores 15A-15B may be in the form of packets similar to those used on the HT interfaces. In other embodiments, any desired communication may be used (e.g. transactions on a bus interface, packets of a different form, etc.). In other embodiments, the processor cores 15A-15B may share an interface to the node controller 20 (e.g. a shared bus interface). Generally, the communications from the processor cores 15A-15B may include requests such as read operations (to read a memory location or a register external to the processor core) and write operations (to write a memory location or external register), responses to probes (for cache coherent embodiments), interrupt acknowledgements, and system management messages, etc.

As described above, the memory 14 may include any suitable memory devices. For example, a memory 14 may comprise one or more random access memories (RAM) in the dynamic RAM (DRAM) family such as RAMBUS DRAMs (RDRAMs), synchronous DRAMs (SDRAMs), double data rate (DDR) SDRAM. Alternatively, memory 14 may be implemented using static RAM, etc. The memory controller 22 may comprise control circuitry for interfacing to the memories 14. Additionally, the memory controller 22 may include request queues for queuing memory requests, etc.

The HT circuits 24A-24C may comprise a variety of buffers and control circuitry for receiving packets from an HT link and for transmitting packets upon an HT link. The HT interface comprises unidirectional links for transmitting packets. Each HT circuit 24A-24C may be coupled to two such links (one for transmitting and one for receiving). A given HT interface may be operated in a cache coherent fashion (e.g. between processing nodes) or in a non-coherent fashion (e.g. to/from peripheral devices 16A-16B). In the illustrated embodiment, the HT circuits 24A-24B are not in use, and the HT circuit 24C is coupled via non-coherent links to the peripheral devices 16A-16B.

The peripheral devices 16A-16B may be any type of peripheral devices. For example, the peripheral devices 16A-16B may include devices for communicating with another computer system to which the devices may be coupled (e.g. network interface cards, circuitry similar to a network interface card that is integrated onto a main circuit board of a computer system, or modems). Furthermore, the peripheral devices 16A-16B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. It is noted that the term “peripheral device” is intended to encompass input/output (I/O) devices.

Generally, a processor core 15A-15B may include circuitry that is designed to execute instructions defined in a given instruction set architecture. That is, the processor core circuitry may be configured to fetch, decode, execute, and store results of the instructions defined in the instruction set architecture. For example, in one embodiment, processor cores 15A-15B may implement the x86 architecture. The processor cores 15A-15B may comprise any desired configurations, including superpipelined, superscalar, or combinations thereof. Other configurations may include scalar, pipelined, non-pipelined, etc. Various embodiments may employ out of order speculative execution or in order execution. The processor cores may include microcoding for one or more instructions or other functions, in combination with any of the above constructions. Various embodiments may implement a variety of other design features such as caches, translation lookaside buffers (TLBs), etc. Accordingly, in the illustrated embodiment, in addition to the L3 cache 60 that is shared by both processor cores, processor core 15A includes an L1 cache 16A and an L2 cache 17A. Likewise, processor core 15B includes an L1 cache 16B and an L2 cache 17B. The respective L1 and L2 caches may be representative of any L1 and L2 cache found in a microprocessor.

It is noted that, while the present embodiment uses the HT interface for communication between nodes and between a node and peripheral devices, other embodiments may use any desired interface or interfaces for either communication. For example, other packet based interfaces may be used, bus interfaces may be used, various standard peripheral interfaces may be used (e.g., peripheral component interconnect (PCI), PCI express, etc.), etc.

In the illustrated embodiment, the L3 cache subsystem 30 includes a cache controller unit 21 (which is shown as part of node controller 20) and the L3 cache 60. Cache controller 21 may be configured to control requests directed to the L3 cache 60. More particularly, as will be described in greater detail below, cache controller 21 may be configured to may reduce the latencies associated with accessing L3 cache 60 while preserving cache bandwidth by selectively requesting data from the L3 cache 60 using an implicit request, non-implicit request, or an explicit request dependent upon such factors as L3 resource availability, and L3 cache bandwidth utilization. For example, cache controller 21 may be configured to monitor and track outstanding L3 requests and available L3 resources such as the L3 data bus, and L3 storage array bank accesses.

It is noted that, while the computer system 10 illustrated in FIG. 1 includes one processing node 12, other embodiments may implement any number of processing nodes. Similarly, a processing node such as node 12 may include any number of processor cores, in various embodiments. Various embodiments of the computer system 10 may also include different numbers of HT interfaces per node 12, and differing numbers of peripheral devices 16 coupled to the node, etc.

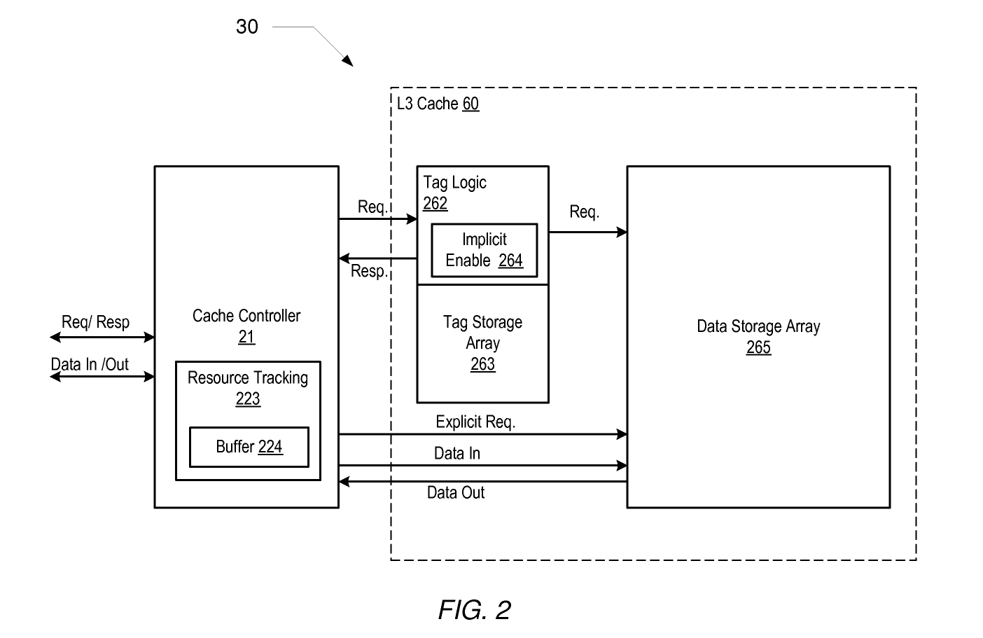

Turning to FIG. 2, a block diagram illustrating more detailed aspects of an embodiment of the L3 cache subsystem of FIG. 1 is shown. Components that correspond to those shown in FIG. 1 are numbered identically for clarity and simplicity. L3 cache subsystem 30 includes cache controller 21, which is coupled to L3 cache 60.

The L3 cache 60 includes a tag logic unit 262, a tag storage array 263, and a data storage array 265. The tag storage array 263 may be configured to store within each of a plurality of locations a number of address bits (i.e., tag) of a cache line of data stored within the data storage array 265. In one embodiment, the tag logic 262 may be configured to search the tag storage array 263 to determine whether a requested cache line is present in the data storage array 265. For example, tag logic 262 may determine whether one or more address bits associated with a read request matches any address tag stored within the tag storage array 263. If the tag logic 262 matches on a requested address, the tag logic 262 may return a hit indication to the cache controller 21, and a miss indication if there is no match found in the tag array 263.

In addition, in one embodiment, depending on the type of request received from cache controller 21, the tag logic 262 may selectively return a hit or miss indication without forwarding the request to the data storage array. More particularly, if cache controller 21 sends a request that includes an implicit enable indication, tag logic 262 may initiate a read request to the data array 265 immediately upon detection of a hit. Thus, for this type of read, tag logic 262 does not wait for the cache controller 21 to initiate the read access. However, if the tag logic 262 determines the cache line is not present, tag logic 262 returns a miss indication to cache controller 21. In another embodiment, tag logic 262 may forward the request address to the data storage array 265 without waiting for tag logic 262 to search the tag storage array 263 to determine whether the requested cache line is present in the data storage array 265. Then if the tag logic determines there is a hit, the tag logic 262 initiates the read access of the data storage array 265. However, if the tag logic 262 determines the request misses in the tag storage array 263, tag logic 262 cancels the request to the data storage array 265 and a read access delay is incurred anyway. On the other hand, if cache controller 21 sends a request that does not include an implicit enable indication (referred to as a non-implicit request), tag logic 262 may only search the tag storage array 263 and report the result (e.g., hit or miss) to cache controller 21 and not perform the actual read access. Thus, when performing an implicit read, if a requested address hits, clock cycles may be saved by not having to wait for the hit to be reported back to the cache controller 21, which would then issue the read request to the data storage array 265. The clock cycle savings may be due at least in part, to the physical distance that the cache controller 21 and the tag logic 262/tag array 263 are from each other.

The cache controller 21 may be configured to selectively provide the implicit request indication with the request that is sent to the tag logic 262 dependent on a variety of factors such as the availability of L3 cache resources as described above. Further, cache controller 21 may be configured to send an explicit request to L3 cache 60. An explicit request refers to a request that is sent directly to the data storage array 265, thereby effectively bypassing tag logic 262. Typically, this type of request is used when the cache line is known to exist within the data storage array 265. One way that cache controller 21 may have the information is to send one or more requests to the tag logic 262 without the implicit enabled indication as described above. As the tag logic 262 returns hit or miss indications, cache controller 21 may track the hit indications and then send explicit requests for those addresses that are known to be hits.

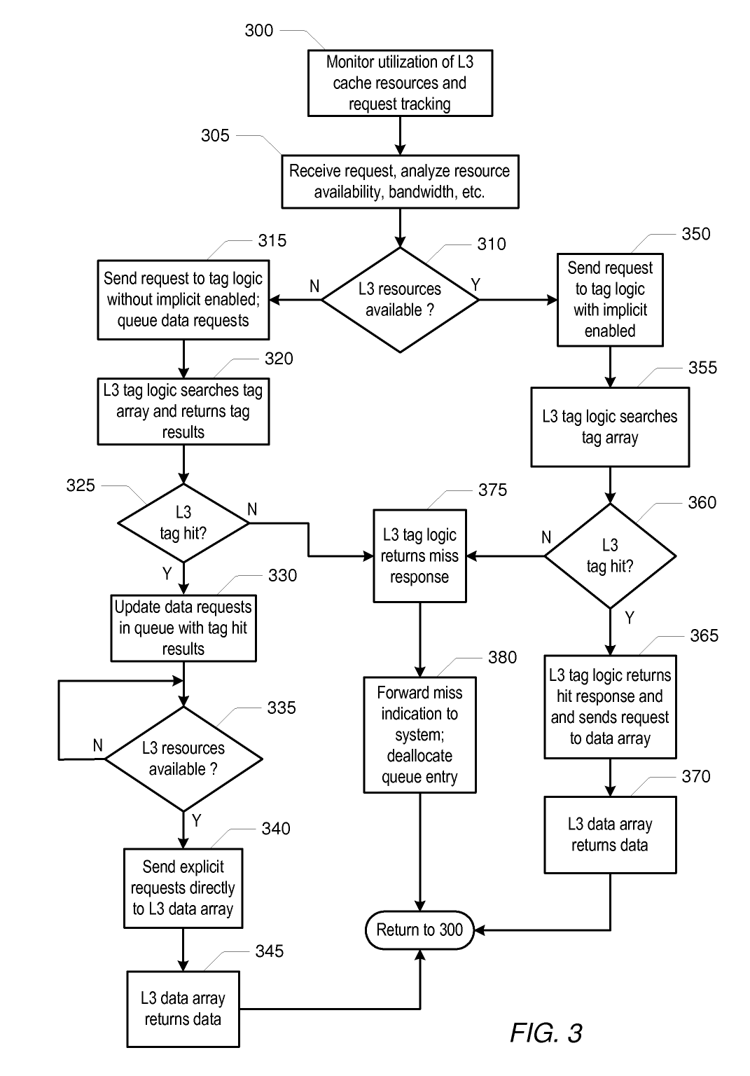

Thus as described in greater detail below in conjunction with the description of FIG. 3, cache controller 21 may be configured to send either implicit, non-implicit, or explicit requests depending on the current utilization/availability of the cache subsystem resources including the factors described above. In one embodiment, to determine the above factors, resource tracking unit 223 within cache controller 21 may be configured to track outstanding requests, which data banks, buffers, and read data buses of L3 cache 60 may be affected by those requests, the number of cycles remaining until completion of each outstanding request, etc. In addition, resource tracking unit 223 may track which addresses hit within tag storage array 263. In one embodiment, resource tracking unit 223 includes one or more buffers 224 that may be used to store request information and returned data associated with the read requests. As such, in one embodiment, cache controller 21 may allocate entries in buffer 224 to store data for each read request sent to tag logic 262. The entries may be deallocated when the data is sent to the requesting processor core or if a miss indication is received from tag logic 262.

FIG. 3 is a flow diagram that describes the operation of one embodiment of the L3 cache subsystem 30 of FIG. 1 and FIG. 2. Referring collectively to FIG. 1 through FIG. 3, in block 300 the resource tracking unit 223 monitors the utilization/availability of the L3 cache resources. For example, resource tracking unit 223 may keep track of which data banks are busy and whether the read data bus is busy, or if they are assumed busy due to previous speculative reads. Further, resource tracking unit 223 may track the number of outstanding requests and how long each of those requests will remain outstanding (in cycles). If cache controller 21 receives a read request from the system, cache controller 21 may analyze the available resources using the information monitored by resource tracking unit 223 (block 305). If the L3 cache 60 resources are determined to not be available (block 310), cache controller 21 may allocate an entry in one or more buffers 224 for the data that is expected to be returned. Cache controller 21 may also send the request to tag logic 262 without the implicit enable indication (block 315). For example, in one embodiment, the request may be packetized and the packet may include a field having one or more bits that serve as the implicit enable indication. The one or more bits may be interpreted by tag logic 262 when the request is received. In such an embodiment, the implicit enable indication bits may be asserted or de-asserted to indicate an implicit or non-implicit request, respectively. Alternatively, the implicit enable indication may be assertion or de-assertion of one or more unused address or other bits included in the request.

Upon receiving the non-implicit request, tag logic 262 begins searching the tag storage array 263 for a tag that matches the address in the request and returns tag results to cache controller 21 (block 320). For a non-implicit requests, tag logic 262 does not send the request to the data storage array 265 on hits. Instead, if there is a match, tag logic 262 returns a hit indication to cache controller 21 (block 325). Cache controller 21 updates the entry within buffer 224 that corresponds to that request (e.g., outstanding requests (referred to as data requests)) that has received a hit indication, but for which the data has not been read from the data storage array 265 (block 330). If cache controller 21 determines the L3 resources are now available (block 335), cache controller 21 may send the outstanding requests directly to the L3 data array 265 as explicit requests (block 340). Since the data is known to be present, the L3 data array 265 performs the read accesses and returns the requested data (block 345). Operation continues as described above in conjunction with block 300.

Referring back to block 335, if the L3 resources are not yet available, cache controller 21 may continue sending non-implicit requests as described above in conjunction with the description of block 315.

Referring back to block 325, if there is no match, tag logic 262 returns a miss indication to cache controller 21 (block 375). In response to receiving the miss indication, cache controller 21 may, in one embodiment, forward the miss indication to the system. Cache controller 21 may also deallocate the entry in buffer 224 that corresponds to the outstanding data request (block 380). Operation continues as described above in conjunction with block 300.

Referring back now to block 310, if the cache controller 21 determines the L3 resources are available, cache controller 21 may send the request to tag logic 262 with the implicit enable indication. For example, as described above the implicit enable indication bit(s) may be asserted (block 350). It is noted that in one embodiment, if there are outstanding data requests, these data requests will have priority over newly received requests, and will cause more non-implicit requests to be generated.

Upon receiving the implicit request, tag logic 262 begins searching the tag storage array 263 for a tag that matches the address in the request (block 355). If there is a match (block 360), tag logic 262 returns the hit indication to cache controller 21 and initiates a read request of the L3 data array 265 (block 365). As the data becomes available, the L3 data array 265 returns the data via the read data bus (block 370). Operation continues as described above in conjunction with block 300.

Referring back to block 360, if there is no match, operation continues as described above in conjunction with the description of block 375 where tag logic 262 returns a miss indication to cache controller 21.

As described above, although implicit reads may reduce some latencies associated with waiting for the cache controller 21 to initiate a read if there is a hit, it is noted that when an implicit read misses (e.g. as describe in block 370), the resources that would have been required (e.g., bus, buffers, and banks) may not be reused due to the latency in the cache controller 21 determining that there was a miss. Thus, a waste of system resources may result for systems that only performed implicit reads. This latency is further increased in systems where there is significant physical distance between the cache controller and the tag logic. In addition, using only explicit reads would allow better scheduling, but at the expense of even longer latencies to get data.

Thus, depending on the utilization and availability of the resources associated with the L3 cache subsystem 30, it may be advantageous for the cache controller 21 to choose either to speculatively read data from the L3 data storage array 265 when system resources are lightly loaded (implicit reads) and wasted resources do not necessarily impact performance or to allow for full resource utilization by gathering hit responses (non-implicit reads) when the system is heavily loaded and explicitly read the data as the resources become available.

It is noted that although the embodiments described above include a node having multiple processor cores, it is contemplated that the functionality associated with L3 cache subsystem 30 (esp. the cache controller 21 and the tag logic 262) may be used in any type of processor, including single core processors. In addition, the above functionality is not limited to L3 cache subsystems, but may be implemented in other cache levels and hierarchies.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor cache memory subsystem comprising:
a cache controller configured to monitor read request resources associated with the cache memory subsystem and to receive a read request for data stored in a data storage array of the cache memory subsystem; and
a tag logic unit coupled to the cache controller and configured to determine whether one or more address bits associated with the read request match any address tag stored within a tag storage array of the cache memory subsystem; and
wherein the cache controller is further configured to selectably send a request for data corresponding to the read request without waiting for a hit indication dependent upon whether read request resources associated with the cache subsystem are available.

2. The cache subsystem as recited in claim 1, wherein in response to determining the read request resources are available, the cache controller is configured to request the data corresponding to the read request from the tag logic unit without waiting for a hit indication from the tag logic unit.

3. The cache subsystem as recited in claim 2, wherein to request the data corresponding to the read request from the tag logic unit without waiting for a hit indication, the cache controller is configured to send to the tag logic unit, the request for data corresponding to the read request with an implicit request indication being asserted.

4. The cache subsystem as recited in claim 3, wherein in response to the read request matching an address tag stored within a tag storage array, the tag logic unit is configured to send to the cache controller a hit indication and to send to the data storage array, the address corresponding to the read request in response to receiving from the cache controller the request for the data corresponding to the read request with the implicit request indication being asserted.

5. The cache subsystem as recited in claim 3, wherein the cache controller is configured to allocate one or more entries in a buffer for storing data associated with the request for data corresponding to the read request sent to the tag logic unit with an implicit request indication being asserted.

6. The cache subsystem as recited in claim 3, wherein in response to determining the read request resources will be available in a predetermined number of clock cycles, the cache controller is configured to wait the predetermined number of clock cycles and to send the request for data corresponding to the read request with the implicit request indication being asserted.

7. The cache subsystem as recited in claim 1, wherein the cache controller is configured to request only tag results from the tag logic unit in response to determining the read request resources are not available.

8. The cache subsystem as recited in claim 7, wherein the cache controller is configured to request only tag results by sending to the tag logic unit, the request for data corresponding to the read request without an implicit request indication being asserted.

9. The cache subsystem as recited in claim 7, wherein the cache controller is configured to send directly to the data storage array, the request for data corresponding to the read request in response to receiving a tag result indicating an address corresponding to the read request is a hit in a tag storage array of the cache memory subsystem.

10. The cache subsystem as recited in claim 7, wherein in response to determining the read request resources have become available, cache controller is configured to send directly to the data storage array, pending requests for data corresponding to read requests that have tag results prior to sending read requests with the implicit request indication being asserted.

11. A method comprising:
monitoring read request resources associated with a cache subsystem of a processor;
receiving a read request for data stored in a data storage array of the cache subsystem; and
selectably sending a request for data corresponding to the read request without waiting for a hit indication dependent upon whether the read request resources associated with the cache subsystem are available.

12. The method as recited in claim 11, further comprising requesting, from a tag logic unit, the data corresponding to the read request without waiting for a hit indication from the tag logic unit of the cache subsystem in response to determining the read request resources are available.

13. The method as recited in claim 12, wherein requesting from the tag logic unit, the data corresponding to the read request without waiting for a hit indication includes sending to the tag logic unit, the request for data corresponding to the read request with an implicit request indication being asserted.

14. The method as recited in claim 12, further comprising sending a hit indication and sending, to the data storage array, the address corresponding to the read request in response to receiving the request for the data corresponding to the read request with the implicit request indication being asserted and in response to the read request matching an address tag stored within a tag storage array.

15. The method as recited in claim 13, further comprising allocating one or more entries in a buffer for storing data associated with the request for data corresponding to the read request sent to the tag logic unit with an implicit request indication being asserted.

16. The method as recited in claim 13, further comprising, in response to determining the read request resources will be available in a predetermined number of clock cycles, waiting for the predetermined number of clock cycles to send the request for data corresponding to the read request with the implicit request indication being asserted.

17. The method as recited in claim 11, further comprising requesting only tag results from a tag logic unit of the cache memory subsystem in response to determining the read request resources are not available.

18. The method as recited in claim 17, wherein requesting only tag results includes sending to the tag logic unit, the request for data corresponding to the read request without an implicit request indication being asserted.

19. The method as recited in claim 17, further comprising sending directly to the data storage array, the request for data corresponding to the read request in response to receiving a tag result indicating an address corresponding to the read request is a hit in a tag storage array of the cache subsystem.

20. The method as recited in claim 17, further comprising in response to determining the read request resources have become available, sending directly to the data storage array, pending requests for data corresponding to read requests that have tag results prior to sending read requests with the implicit request indication being asserted.
